(19) United States
(12) Patent Application Publication
(10) Pub. No.: US 2013/0191235 A1
(43) Pub. Date: Jul. 25, 2013

(54) SYSTEM FOR REWARDING AND MOTIVATING NON-WINNING BIDDERS

(71) Applicants: Daniel Montero-Mask, Lake Worth, FL (US); Michael Weisman, Providence, RI (US)

(72) Inventors: Daniel Montero-Mask, Lake Worth, FL (US); Michael Weisman, Providence, RI (US)

(21) Appl. No.: 13/747,468

(22) Filed: Jan. 22, 2013

Related U.S. Application Data
(60) Provisional application No. 61/589,107, filed on Jan. 20, 2012.

(51) Int. Cl. G06Q 30/08

(52) U.S. Cl. CPC G06Q 30/08
USPC 705/26.3

(57) ABSTRACT

A system for rewarding and motivating non-winning bidders is disclosed. The system may list an item of a seller for an auction at a first price. The system may receive a first bid for the item from a first bidder at the first price. The first bidder may be granted control of the auction based on the first bid. The system may then receive a second bid for the item from a second bidder at a second price. The second bidder may control the auction if the second bid is at least a predetermined threshold amount above the first price. The system may request a response from the first bidder to approve the second bid if the second bid is lower than the predetermined threshold amount above the first price. The system give the first bidder a reward based on the difference between the first price and the second price.

### CROSS REFERENCE TO RELATED APPLICATIONS AND PRIORITY

The present application claims priority to U.S. Provisional Application No. 61/589,107, filed Jan. 20, 2012, the entirety of which is hereby incorporated by reference.

### FIELD OF THE INVENTION

The present application relates to transaction and auction systems, and more particularly, to a system for rewarding and motivating non-winning bidders.

### BACKGROUND

In today's increasingly technological culture, people and businesses regularly utilize the Internet to access various types of software services, consume different types of content, conduct and participate in business transactions, and carry out a variety of other tasks and functions. For example, instead of participating in traditional in-person live auctions, people have grown to accept and participate in online auctions, which are hosted on various auction websites or other types of websites. In typical online auctions, a seller will list an item for sale for direct purchase without any bidding or will list the item for bidding for a designated period of time that is set by the seller. When the item is listed for bidding by the seller, a first bidder may bid on the item with a particular bid price that may match the seller's initial list price. If no further bidders bid on the item after the first bidder, the first bidder may win the auction at the bid price that the first bidder made. However, if a second bidder is interested in the item and bids a higher price than the first bidder made during the auction, the price of the item will rise to the second bidder's price and the second bidder will win the auction if no subsequent bidders bid a higher price on the item by the end of the auction. This online auction process and other online auction variations have become popular as people become increasingly comfortable with computer technologies.

As the widespread use of mobile devices, such as smartphones, laptops, and computer tablets continues to increase, along with the recent proliferation of social networking, people are increasingly utilizing the Internet to keep in touch with their personal contacts, search for information, access and consume media content, participate in online transactions, and establish online identities that provide information about themselves to the world or to various selected contacts. Nevertheless, there are many drawbacks to currently existing online auctions and online sales portals. For example, it is often time consuming to create the initial listing for the auction item that includes the price, the photos, the shipping methods, and the description of the auction item. Also, many times sellers are charged high fees for listing their auction items by the company that hosts the listings for the sellers, and sellers are even charged fees for relisting the auction item if the auction item does not sell in the initial listing. Additionally, the listed item may not sell in a timely manner, may not even sell at all, or may be bid up to very high prices that can make buyers less hesitant to bid on future auctions. Moreover, many current auction sites and sellers have to deal with buyers that bid on an auction item and subsequently do not pay for the auction item, and also have to deal with people that participate in an ever-increasing amount of online fraud.

### SUMMARY

A system and accompanying methods for rewarding and motivating non-winning bidders are disclosed. In particular, the system may reward and motivate non-winning bidders in offline or online auctions. In most traditional auctions today, a bidder typically does not receive any benefit unless the bidder actually wins the auction. However, the systems and methods disclosed herein provide mechanisms whereby non-winning bidders may receive compensation or other rewards simply for participating in the auction, which may also be known as a “picnick.” For example, any bidder who bids on the auction item in the auction may receive a percentage of each increase in price after the initial bid. As a result, each bidder may accumulate funds for using in other auctions or simply save the accumulated funds into their bank account for a processing fee.

Additionally, the systems and methods may enable a non-winning bidder to gain virtual power over an auction item by enabling the non-winning bidder to accept and decline bids based on a percentage threshold or ceiling amount, which may be based on the price of the auctioned item. In one embodiment, for example, a non-winning bidder may be able to gain complete power over the auction by bidding a required threshold or percentage amount above a designated auction price. Alternatively, the non-winning bidder may be able to gain power over the auction if the seller or a previous bidder accepts the bid from the non-winning bidder. In this scenario, the non-winning bidder may gain control over the auction even if the non-winning bidder did not satisfy the required threshold or percentage amount above the auction price with his or her bid. By rewarding non-winning bidders in such manners, the participation in auctions and the popularity of auctions may be increased and improved.

In one embodiment, a system for rewarding and motivating non-winning bidders is disclosed. The system may include a memory that stores instructions and a processor that executes the instructions to performing various operations. An operation of the system may include listing an item of a seller for an auction for a predetermined amount of time. The item may be listed at a first price and the seller may have control of the auction. An additional operation of the system may include receiving a first bid for the item from a first bidder at the first price. The first bidder may be from a plurality of bidders. The system may perform the operation of granting control of the auction to the first bidder based on receiving the first bid for the item at the first price. The system may then perform the operation of receiving a second bid for the item from a second bidder at a second price, wherein the second bidder is from the plurality of bidders. If the second bid at the second price is at least a predetermined threshold amount above the first price, the system may perform the operation of granting control of the auction to the second bidder. However, if the second price is lower than the predetermined threshold amount above the first price, the system may perform the operation of requesting a response from the first bidder to accept or reject the second bid at the second price. If the response from the first bidder indicates that the first bidder accepts the second bid at the second price, the system may perform the operation of granting control of the auction to the second bidder. Furthermore, the system may perform the operation of providing a reward to the first bidder. The reward provided to the first bidder may be a first percentage of a difference between the first price and the second price.

In another embodiment, a method for rewarding and motivating non-winning bidders is disclosed. The method may include listing an item of a seller for an auction for a predetermined amount of time, wherein the item is listed at a first price. Additionally, the method may include receiving a first bid for the item from a first bidder at the first price, wherein the first bidder is from a plurality of bidders. The method may also include granting, by utilizing instructions from memory and executed by a processor, control of the auction to the first bidder based on receiving the first bid for the item at the first price. The method may include receiving a second bid for the item from a second bidder at a second price. The second bidder may also be from the plurality of bidders. If the second bid at the second price is at least a predetermined threshold amount above the first price, the method may include granting control of the auction to the second bidder. However, if the second price is lower than the predetermined threshold amount above the first price, the method may include requesting a response from the first bidder to accept or reject the second bid at the second price. If the response from the first bidder indicates that the first bidder accepts the second bid at the second price despite the second price being lower than the predetermined threshold amount, the method may include granting control of the auction to the second bidder. Furthermore, the method may include providing a reward to the first bidder. The reward may be a percentage of a difference between the first price and the second price.

According to another exemplary embodiment, a computer-readable device having instructions for rewarding and motivating non-winning bidders is provided. The computer instructions, which when loaded and executed by a processor, may cause the processor to perform operations including: listing an item of a seller for an auction for a predetermined amount of time, wherein the item is listed at a first price; receiving a first bid for the item from a first bidder at the first price, wherein the first bidder is from a plurality of bidders; granting control of the auction to the first bidder based on receiving the first bid for the item at the first price; receiving a second bid for the item from a second bidder at a second price, wherein the second bidder is from the plurality of bidders; granting control of the auction to the second bidder if the second bid at the second price is at least a predetermined threshold amount above the first price; requesting a response from the first bidder to accept or reject the second bid at the second price if the second price is lower than the predetermined threshold amount above the first price; granting control of the auction to the second bidder if the response from the first bidder accepts the second bid at the second price; and providing a reward to the first bidder, wherein the reward is a first percentage of a difference between the first price and the second price.

These and other features of the systems and methods for rewarding and motivating non-winning bidders are described in the following detailed description, drawings, and appended claims.

### BRIEF DESCRIPTION OF THE DRAWINGS

FIG. 1 is a schematic diagram of a system for rewarding and motivating non-winning bidders according to an embodiment of the present disclosure.

FIG. 2 is a schematic diagram of a web page that displays an auction listing according to an embodiment of the present disclosure.

FIG. 3 is a table illustrating sample price ranges and corresponding threshold percentage values for bids that may be utilized in a system for rewarding and motivating non-winning bidders according to an embodiment of the present disclosure.

FIG. 4 is a table illustrating sample distributions that are given to the original seller and the first five virtual owners of an item that is being auctioned according to an embodiment of the present disclosure.

FIG. 5 is a flow diagram illustrating a sample method for rewarding and motivating non-winning bidders according to an embodiment of the present disclosure.

FIG. 6 is a schematic diagram of a machine in the form of a computer system within which a set of instructions, when executed, may cause the machine to perform any one or more of the methodologies of the system for rewarding and motivating non-winning bidders.

### DETAILED DESCRIPTION OF THE INVENTION

A system 100 and accompanying methods for rewarding and motivating non-winning bidders are disclosed. In one embodiment, the system 100 may reward and motivate non-winning bidders in offline or online auctions. However, in other embodiments, the system 100 may be utilized to reward and motivate people in any type of transaction or interchange. Auctions or other types of online transactions according to the present disclosure may otherwise be known as a “picnick.” The system 100 and methods disclosed herein enable non-winning bidders to receive rewards, such as compensation, for simply for participating in a particular auction. Notably, the non-winning bidders do not have to actually win the auction to receive a reward. For example, any bidder who bids on an auction item in an auction may receive a percentage of each increase in the price of the auction item after the initial bid. As a result, each bidder may accumulate funds for using in other auctions or transactions, or may simply save the rewards for their personal use or savings.

Additionally, the system 100 and methods may enable a non-winning bidder to obtain virtual power over an auction item by enabling the non-winning bidder to accept and decline bids based on a percentage threshold or ceiling amount, which may be based on the price of the auctioned item. In one embodiment, for example, the non-winning bidder may be able to gain complete power over the auction by bidding a required threshold or percentage amount above a current auction price. Once the non-winning bidder gains control over the auction, the non-winning bidder may be able to reject or accept bids from subsequent bidders up to a threshold amount above the bid of the non-winning bidder. Alternatively, the non-winning bidder may be able to gain control over the auction, even if the non-winning bidder did not satisfy the required threshold or percentage amount above the auction price with his or her bid. This may occur if the seller or a previous bidder with control over the auction decides to accept the bid from the non-winning bidder. By providing non-winning bidders with rewards and virtual control over auctions and transactions, people will be more likely to participate in such online auctions and transactions and encourage friends to participate in such transactions.

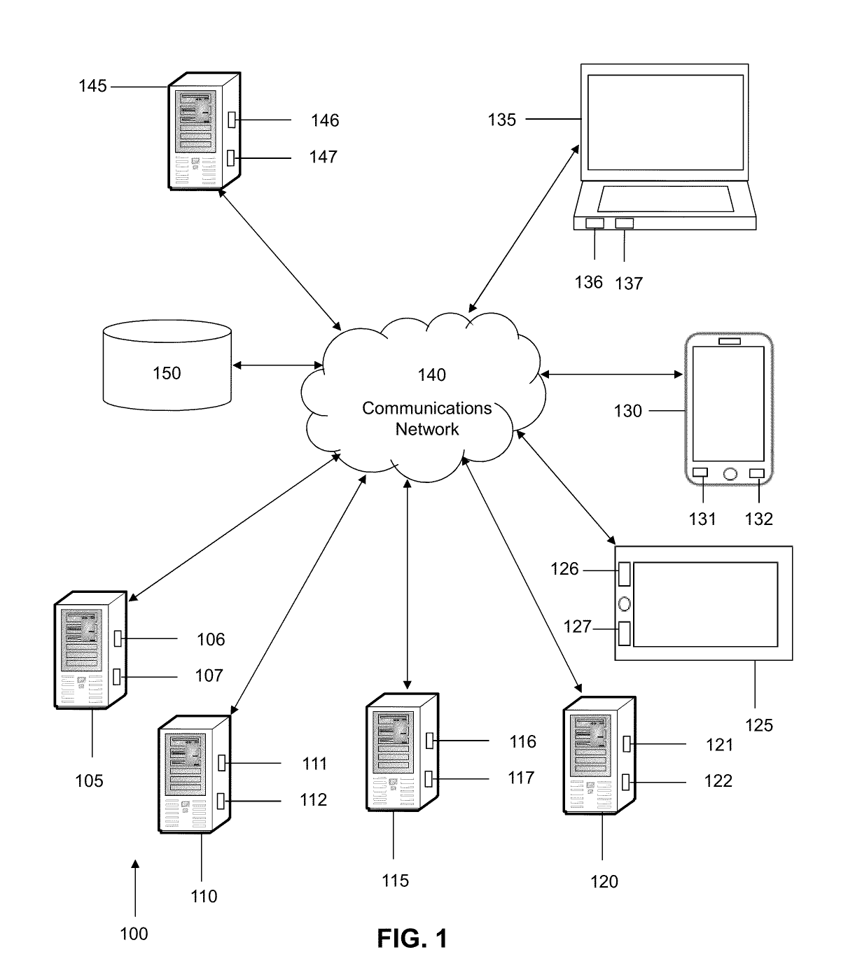

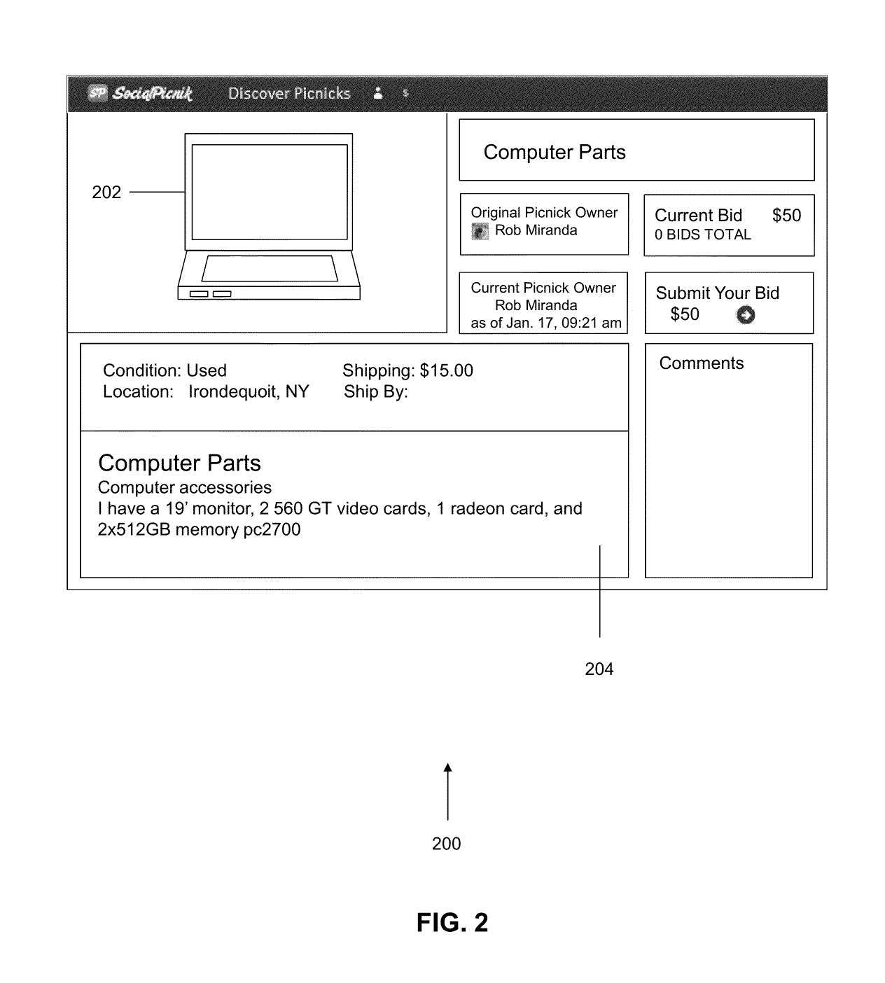

Referring to the drawings and in particular to FIGS. 1-2, a system 100 for rewarding and motivating non-winning bidders is schematically illustrated. The system 100 may include a seller device 105, a first bidder device 110 associated with a first bidder, a second bidder device 115 associated with a second bidder, a third bidder device 120 associated with a third bidder, a fourth bidder device 125 associated with a fourth bidder, a fifth bidder device 130 associated with a fifth bidder, a sixth bidder device 135 associated with a sixth bidder, a communications network 140, a server 145, and a database 150. The seller device 105 may include a memory 106 that stores instructions and a processor 107 that executes the instructions from memory 106 to perform various operations for the seller device 105. Additionally, the first bidder device 110 may include a memory 111 and a processor 112, the second bidder device 115 may include a memory 116 and a processor 117, and the third bidder device 120 may include a memory 121 and a processor 122. The memories and processors for the first, second, and third bidder devices 110, 115, 120 may be used for performing various operations for each of the bidder devices 110, 115, 120 respectively. In one embodiment, the first bidder device 110, the second bidder device 115, and the third bidder device 120 may be any type of computer device, such as, but not limited to, a computer, a server, or any other suitable computing device. The fourth bidder device 125 may also include a memory 126 and a processor 127 for performing various operations of the fourth bidder device 125. In one embodiment, the fourth bidder device 125 may be a computer tablet, as shown in FIG. 1, or any other computing device. The fifth bidder device 130 may also include a memory 131 and a processor 132 for performing various operations of the fifth bidder device 130. In one embodiment, the fifth bidder device 130 may be a smartphone, as shown in FIG. 1, or any other suitable computing device. The sixth bidder device 135 may include a memory 136 and a processor 137 configured to perform various operations for the sixth bidder device 135. In one embodiment, the sixth bidder device 135 may be a laptop, as shown in FIG. 1, or any other suitable computing device.

Notably, the system 100 may perform any of the operative functions disclosed herein by utilizing the processing capabilities of server 145 and the storage capacity of the database 150. The server 145 may include one or more memories 146 and one or more processors 147 that may be configured to process any of the various functions of the system 100. The one or more processors 147 may be software, hardware, or a combination of hardware and software. Additionally, the memory 146 of the server 145 can store instructions that the processors 147 may execute to perform various operations of the system 100. For example, the server 145 may assist in processing loads handled by the various devices in the system 100 and any other suitable operations conducted in the system 100, or otherwise. In one embodiment, multiple servers 145 may be utilized to process the functions of the system 100. The server 145 and other devices in the system 100, may utilize the database 150 for storing data about the auction, currency values for the bidders, bidder information, auction listing information, social networking information, or any other information that is associated with the system 100. In one embodiment, multiple databases 150 may be utilized to store data in the system 100.

Additionally, the communications network 140 of the system 100, which may be utilized to link all the devices in the system 100 to one another such that information and data may be transferred between devices in the system 100. The communications network 140 may include, but is not limited to including, a wireless network, an ethernet network, a satellite network, a broadband network, a cellular network, a private network, a cable network, the Internet, an internet protocol network, any network, or any combination thereof. Notably, the system 100 may utilize a combination of software and hardware to perform the operative functions and services of the system 100 disclosed herein.

Operatively, the system 100, as shown in FIG. 1, may be configured to reward and motivate non-winning bidders. In one embodiment, the system 100 may enable a seller to list an item for auction at a particular price for a predetermined period of time, such as by utilizing seller device 105. Additionally, the seller may include a description of the item, its condition, images of the item, and any other relevant information associated with the item on the listing. In one embodiment, the seller may not be charged for the auction listing of the item. The listing may be displayed on a web page 200 of the system 100. As an example, the web page 200 illustrates an item for sale by the seller, which in this case may be a computer 202, along with accompanying computer parts. The description 204 of the computer 202 for sale may also be displayed on the web page 200 that generated by the system 100 for the auction. The web page 200 may also provide information relating to the price, the seller, the current bidder, the original owner of the auction, the current owner of the auction, along with any other necessary information. In an embodiment, once the item auction is activated to be viewed on the auction web page 200, the auction listing may be posted to the seller's social networking page or any other desired internet page so that others may be able to view the auction or access the web page 200. The listing, for example, may be accessed via the seller's social networking online profile or identity.

Once the auction has been listed on the web page 200, the system 100 may receive, at server 145 for example, a first bid for the item from a first bidder at a first price, which may be the price that the seller listed the item for. The first bidder may utilize first bidder device 110 to relay the bid to the server 145 so that the system 100 receives the bid. At this point, the system 100 may grant at least partial control of the auction to the first bidder based on receiving the first bid for the item at the first price. When the first bidder is granted control of the auction, the first bidder may be deemed a “virtual owner” of the auction in that the first bidder may be able to reject or accept bids from subsequent bidders up to a threshold amount above the first price bid by the first bidder. A “virtual owner” may, in one embodiment, have any type of control over the auction, such as, but not limited to, the ability to accept or reject bids, adjust certain portions of the auction itself, change certain parameters of the auction, or perform any other form of control over the auction. By having this power, the first bidder may have the feeling of having actual ownership of the item and may allow the first bidder to decide if a subsequent bidder is a good bidder to help market the auction item. In one embodiment, even when the first bidder becomes a “virtual owner,” the seller may still retain some control over the auction. For example, in one embodiment, the seller may be the only one that can shut down the auction, change the duration for the auction, change the description for the item, add photos of the item, reject or accept certain bids from particular bidders, or make certain other important adjustments to the auction. In one embodiment, the seller may give additional power and control to bidders. For example, the seller may give complete power over the auction to any bidder who has had their bid accepted during the auction. In one embodiment, complete power may mean that the bidder with power and control can accept or decline any bids without having a ceiling or percentage threshold to be concerned with. In one embodiment, the bidder given the power by the seller may still be required to pay whatever amount the auction item's price has been raised to through potential bid-offers.

When the first bidder has become the “virtual owner” of the auction, the auction listing may be posted by the system 100 to the first bidder's social networking page or any other desired internet page so that others may be able to view the auction or access the web page 200 from the first bidder's social networking profile or identity. After this first bid, the system 100 may receive a second bid for the item from a second bidder at a second price. The second bid from the second bidder may be received via the second bidder device 115, for example. If the second bid at the second price is at least a predetermined threshold amount above the first price that the first bidder bid, the system 100 may automatically grant at least partial control of the auction to the second bidder. However, if the second price is lower than the predetermined threshold amount above the first price, then the system 100 may transmit a request for a response from the first bidder to either accept or reject the second bid at the second price. If the first bidder rejects the second bid price that is lower than the predetermined threshold amount above the first price, then the first bidder may retain control over the auction. On the other hand, if the first bidder accepts the second bid, despite the second bid being below the predetermined threshold amount above the first price, then the second bidder will become the new “virtual owner” of the auction and the first bidder will no longer be the current “virtual owner” of the auction. If the second bidder does become the “virtual owner,” the auction listing may be posted by the system 100 to the second bidder's social networking page or any other desired internet page so that others may be able to view the auction or access the web page 200 from the second bidder's social networking profile or identity. Virtual ownership of the auction may change as subsequent bidders bid on the auction item. As a result, virtual ownership of the auction may change hands multiple times during an auction.

At this point or at other designated times, a process of bid increment distribution may be initiated by the system 100 so that non-winning bidders may be rewarded by the system 100. Specifically, a percentage of the increase in the bid price between the first bidder's bid and the second bidder's bid may be split between the first bidder and the original seller based on a particular threshold value. As an example, if the bid increment from the first bid is $10.00 or less, 1% of the increase may be given to the company hosting the auction, 49.5% may go to the original seller, and 49.5% may go to the first bidder. However, if the bid increment from the first bid is over $10.00, then 1% may be given to the company hosting the auction, 79.5% may go to the original seller, and 19.5% may go to the first bidder. If a third bidder bids on the item, a similar process may be executed, however, this time, the second bidder may be rewarded in addition to rewarding the first bidder, the original seller, and the company hosting the auction. A percentage of the increase in the bid price between the second bidder's bid and the third bidder's bid may be split between the first bidder, the second bidder, and the original seller based on a particular threshold value. As an example, if the bid increment is $10.00 or less when the third bidder bids, 1% may go to the company hosting the auction, 54% may go to the original seller, 15% may go to the first bidder, and 25% may go to the second bidder. If the bid increment is over $10.00, then 1% may be given to the company hosting the auction, 80% may go to the original seller, 7.5% may go to the first bidder, and 11.5% may go to the second bidder.

Continuing with the above example, if a fourth bidder bids on the item a percentage of the increase in the bid price between the third bidder's bid and the fourth bidder's bid may be split between the first bidder, the second bidder, the third bidder, and the original seller based on a particular threshold value. For example, if the fourth bidder bids and the bid increment is $10.00 or less when the fourth bidder bids, 1% may go to the company hosting the auction, 55% may go to the original seller, 10% may go to the first bidder, 15% may go to the second bidder, and 19% may go to the third bidder. If the bid increment is over $10.00 for the fourth bid, then 1% may be given to the company hosting the auction, 77% may be given to the original seller, 5% may be given to the first bidder, 7% may be given to the second bidder, and 10% may be given to the third bidder. If a fifth bidder decides to bid on the item and if the bid increment is $10.00 or less when the fifth bidder bids, 1% may go to the company hosting the auction, 55% may go to the original seller, 7% may go to the first bidder, 10% may go to the second bidder, 10% may go the third bidder, and 18% may go to the fourth bidder. If the bid increment is over $10.00 for the fifth bid, then 1% may be given to the company hosting the auction, 75% may be given to the original seller, 2.5% may be given to the first bidder, 2.5% may be given to the second bidder, 5% may be given to the third bidder, and 15% may be given to the fourth bidder.

With regards to additional bids beyond a fifth bid and if the bid increment is $10.00 or less, 1% may go to the company hosting the auction, 55% may go to the original seller, bidders one through five may split 20%, and the remaining bidders may split the remaining percentage. In one embodiment, the remaining bidders may receive nothing and bidders one through five may split 44%. If the bid increment is over $10.00 , then 1% may be given to the company hosting the auction, 70% may be given to the original seller, 14.5% may be split between bidders one through five, and 14.5% may be split between the remaining bidders. In another embodiment, each bid must be accepted by the “virtual owner” of the auction, that is the bidder who is currently in power or is the seller of the auction item. In yet another embodiment, only the original seller, the company hosting the auction, and “virtual owners” may be given rewards. In such an embodiment, intermediary bidders that do not become “virtual owners” may not be given rewards. Of course, any and all of the percentages for distribution may be adjusted upwards or downwards to each of the rewards recipients as desired. At the end of the auction, a notification may be sent by the system 100 to the winning bidder indicating that the winning bidder has won the auction.

In another example according to the present disclosure, a seller may accept a bid from a first bidder for $200 for an item (e.g. charity, house, job, etc.) that the seller has listed for sale. At this point, the first bidder may be given the power to take bids from anyone else that bids on the item in the auction and be a “virtual owner.” If the threshold ceiling amount is 5%, then the first bidder may only decline bids until a bid of $210 is placed (5% of $200 being $10, which added to $200 gives $210). If a bidder or another random user bidding on the item comes to the auction listing and bids $205, then the price of the auction item may rise to $205 on the auction page that is displayed to the public. At this point, only bids over $205 may be placed. In one embodiment, the price change of the auction item may take effect on the web page 200 even before the bid is accepted or rejected. This may serve to stop multiple bids of the same amount from being entered into the system 100. In one embodiment, the first bidder may not see the bid for $205 before other bids are placed on the auction item, so the bids for $205, $206, and $208 may be waiting for his or her acceptance. If this is the case, even though the price of the item on the web page 200 is $208 (the highest bid placed at this point), the first bidder may still accept the bid for $205. If the first bidder accepts this bid, then the bidder who entered the accepted bid may gain power and control over the auction item and become the “virtual owner.” This bidder may be designated as the second bidder and second owner. At this point, the bids for $206 and $208 are still waiting to be declined or accepted. However, it is the second bidder, who is the current “virtual owner,” who has the power to decline or accept the $206 and $208 bids. Since the second bidder has gained virtual power (i.e. virtual ownership of the auction item) based on the $205 bid, the second bidder may be restricted to a threshold of 5% of $205 (5% of $205 being $10.25, which added to $205 equals 215.25). If a new bid passes the second bidder's threshold ceiling, then the new bid may be automatically accepted. For example, once a bid of $215.25 is placed, the bid may be automatically accepted by the system and power may be virtually given to the bidder who bid $215.25.

As another example according to the present disclosure, a seller may list an item for auction for $500 by utilizing the system 100. A first bidder may utilize first bidder device 110 to make a first bid of $500 for the item. At this point, the first bidder may become a “virtual owner” of the auction up to a desired threshold percentage above the bid price. A second bidder may come and bid $550 for the item. If the second bidder's bid is accepted, the second bidder may now become the “virtual owner” of the auction. If a third bidder comes in and bids $720 for the item and the third bidder's bid has been accepted, the third bidder may become the “virtual owner” of the item. This process may continue until the auction ends, which may be a predetermined amount of time set by the seller for the auction. Once the auction ends, the final bidder may pay the final price of the auction via the system 100. Then, the system 100 may distribute funds to the company hosting the auction, the seller, and “virtual owner” bidders based on desired percentages. As a sample distribution, the system 100 may distribute $500 to the seller at the end of the auction. The second bid made by the second bidder accounted for a $50 increase in price from the original $500 bid. This $50 increase may be split as follows: 2.5% may go to the company hosting the auction, 83% may go to the seller, and 14.5% may go to the first bidder. This process of giving distributions may be continued for each bid increment thereafter. Of course, the percentages may be changed as desired. In one embodiment, only when the final bidder (the actual buyer) receives the item, are the distributions made.

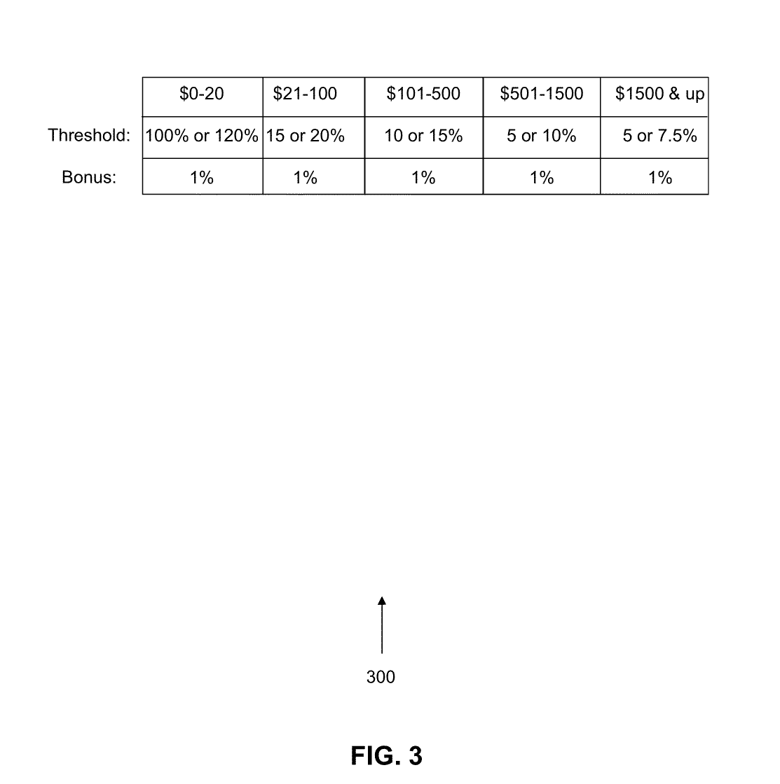

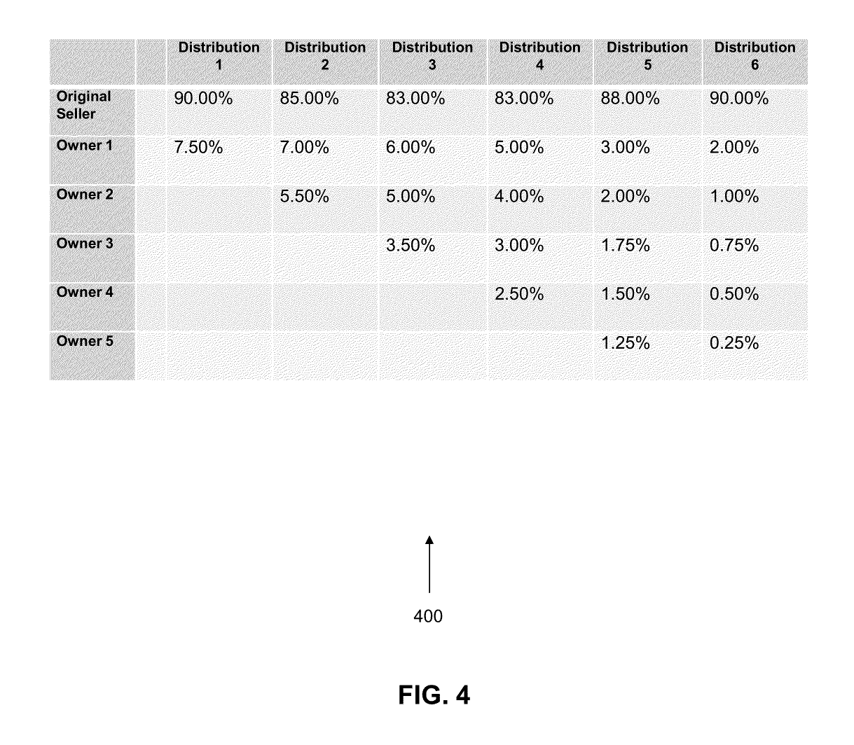

Referring now also to FIG. 3, a table 300 illustrating sample price ranges and corresponding threshold values for bids that may be utilized in the system 100 is shown. The first row of the table 300 shows sample threshold percentages for becoming a “virtual owner.” In one embodiment, the second threshold percentage shown in each column may apply to the first five owners and the first threshold percentage may apply to subsequent owners. The second row of the table 300 shows sample bonus percentages that are given at the end of an auction. The columns of the table 300 show various price ranges that go with particular thresholds and bonuses for a particular item. Referring now also to FIG. 4, a table 400 illustrating sample distributions that are given to the original seller and the first five virtual owners of an item that is being auctioned is shown. As an example, which utilizes the figures in table 300 and table 400, the system 100 may include a seller and five bidders. The seller may put an item up for auction at a price of $10. The first bidder may bid 10 dollars. The first bidder may now become the “virtual owner.” The second bidder may come in and bid $25, which, according to table 300, is above the threshold value for automatically gaining virtual ownership. The first distribution as shown in table 400 may include distributing 90% of the $15 dollar difference between the $10 first bid and the $25 second bid to the original seller, 7.5% of the $15 dollar difference between the $10 first bid and the $25 second bid may go to the first bidder, and company hosting the auction may get 2.5% of the $15 dollar difference between the $10 first bid and the $25 second bid.

If, in the previous example, the second bidder bids between 10.01 and 22 dollars, however, the first bidder (“owner 1” according to table 400) may still have control and the first bidder can reject the second bidder's bid. For example, if the second bidder bids $15, the first bidder can reject the $15 bid and thus prevent the second bidder from becoming the new “virtual owner.” If the time period for the auction ends without any additional bids after the second bidder was rejected, the first bidder will pay $15 for the auction item because even though the first bidder rejected the second bidder's bid of $15, the auction price of the item rose to $15 when the second bidder made the bid of $15. If, however, the second bidder bids $15 and the first bidder accepts the bid instead of rejecting the bid, the second bidder will become the “virtual owner.” At this point, the second bidder will now have control and may be known as “owner 2” as shown in table 400. For distribution purposes, the seller may get 90% of the $5 spread between the first and second bid, owner 1 (the first bidder in this case) may get 7.5% of the $5 spread between the first and second bid, and company hosting the auction may get 2.5% of the $5 spread between the first and second bid. If a third bidder comes in, the third bidder would have to bid at least $15+$18 (120% of $15=$18), which is $33, to take control from the second bidder. This is because $15 is still a value in the first column of table 300 and would need a 120% increase according to table 300 to jump to another range of prices. For the purposes of this example, the third bidder may bid $21. If the second bidder (owner 2) accepts the third bidder's bid, the third bidder becomes “owner 3” and now the $6 dollar spread between the $15-$21 bids may split up as 85% for original seller, 7.00% for the first bidder (owner 1), 5.5% for the second bidder (owner 2), and 2.5% for the company hosting the auction. If a fourth bidder comes and bids $25.20, the fourth bidder will automatically become owner 4. This is because the previous bid of $21 made by the third bidder places the analysis within the second column of table 300. As a result, the fourth bidder only needs to bid 20% over the $21 previous bid to gain automatic control of the auction. Twenty percent of $21 is $4.2, which would require a bid of $25.20 for the fourth bidder to gain control.

Continuing with the analysis, a fifth bidder would have to bid $30.24 to take control. A sixth bidder would have to bid 20% higher than 30.24, which is $36.29, to take control. For distribution purposes, the $6.29 spread between the fifth and sixth bid may be split as follows: 90% of the spread to the original seller, 2.00% of the spread to the first bidder (owner 1), 1.00% of the spread to the second bidder (owner 2), 0.75% of the spread to the third bidder (owner 3), 0.50% of the spread to the fourth bidder (owner 4), 0.25% of the spread to the fifth bidder (owner 5), 2.5% of the spread to the company hosting the auction. In this distribution, which is distribution 6 as shown in FIG. 4, there is still 3% of the spread left after the other distributions have been given out. Two percent of the remaining 2% may be split by all owners in the auction after owner 5 in an equal fashion or any other desired fashion. The remaining 1% may be given as bonus (see FIG. 3 for bonus ranges) to whichever owner of all the owners caused the biggest jump in price between bids. A seventh bidder would have to bid 15% higher than $36.29 to take control. This would be because there have been at least five owners and now the percentages used would be the first percentage listed in column 2, row 2 of table 3. The process can continue for subsequent bidders until the auction ends and the system 100 may distribute funds based on any desired basis.

Notably, the percentage and threshold numbers provided herein are for illustration and example purposes only. The examples provided may be extended to any number of levels and can also be applied by item value (i.e. multiple matrices). For example, instead of increments of $10.00 and under and $10.00 and over, the increments may be $15.00 and under and $15.00 and over. Additionally, instead of 1% going to company hosting the auction, 49.5% to the seller and 49.5% to the first bidder, the percentages can be 5% going to the company hosting the auction, 40% to the seller and 55% to the first bidder. All numbers can be changed to the need of each individual situation (and/or picnik). This process may be repeated for subsequent bidders until the auction ends. Thus, the system allows for the rewarding of non-winning bidders.

Although FIG. 1 illustrates a specific example configuration of the various components of the system 100, the system 100 may include any configuration of the components, which may include using a greater or lesser number of the components. For example, the system 100 is illustratively shown as including a seller device 105, a first bidder device 110, a second bidder device 115, a third bidder device 120, a fourth bidder device 125, a fifth bidder device 130, a sixth bidder device 135, a server 145, and a database 150. However, the system 100 may include any number of seller devices 105, any number of bidder devices 110, 115, 120, 125, 130, 135, any number of servers 145, any number of databases 150, or any number of any of the other components in the system 100. Furthermore, in one embodiment, substantial portions of the functionality of the system 100 may be performed by the server 145 without the needs for the database 150.

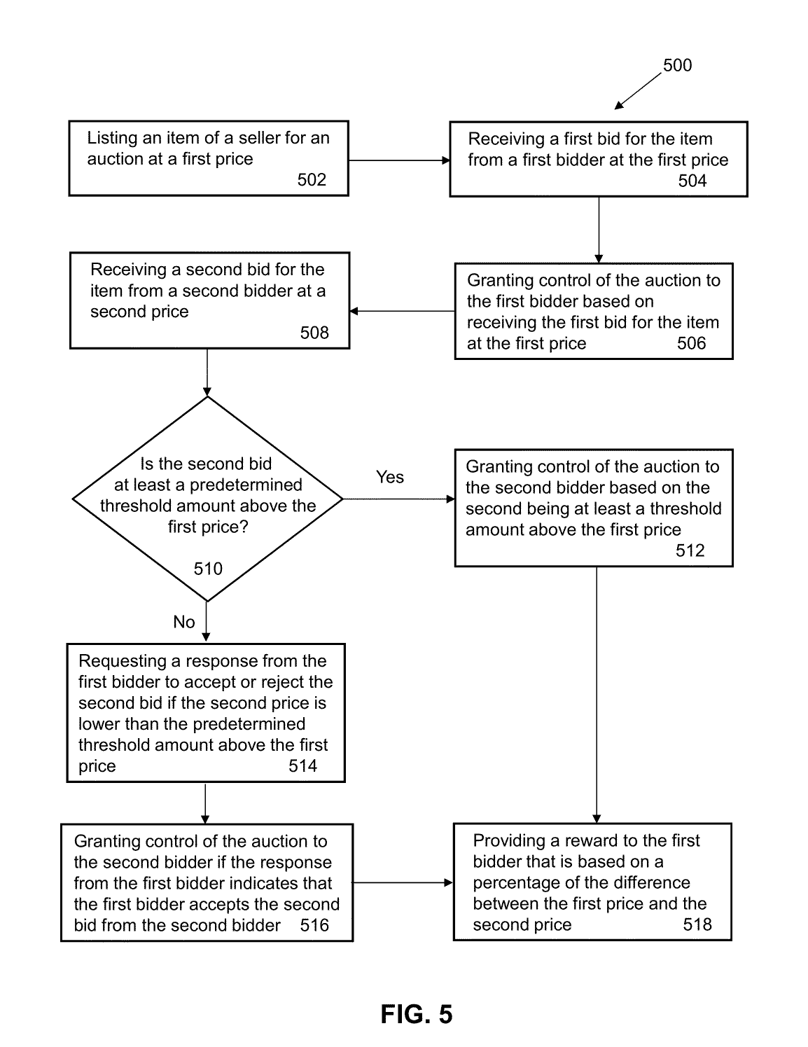

As shown in FIG. 5, an exemplary method 500 for rewarding and motivating non-winning bidders is schematically illustrated. The method 500 may include, at step 502, listing an item of a seller for an auction for a predetermined amount of time, wherein the item is listed at a first price. In one embodiment, the listing of the item of the seller may be performed with the assistance of the server 145, database 150, the seller device 105, any combination thereof, or any other appropriate device. At step 504, the method 500 may include receiving a first bid for the item from a first bidder at the first price. The first bidder may be from a plurality of bidders that may be bidding on the auction. In one embodiment, the first bid for the item may be received from first bidder device 110 or any other appropriate device. At step 506, the method 500 may include granting control of the auction to the first bidder based on receiving the first bid for the item at the first price. In one embodiment, control of the auction may be granted by utilizing the server 145, the database 150, any combination thereof, or any other appropriate device. The method 500, at step 508, may include receiving a second bid for the item from a second bidder at a second price. The second bidder may also be from the plurality of bidders. In one embodiment, the second bid for the item from the second bidder may be received from the second bidder device 115 via the communications network 140, or by utilizing any other appropriate device.

At step 510, the method 500 may include determining if the second bid is at least a predetermined threshold amount above the first price. In one embodiment, the determination of whether the second bid is at least a predetermined threshold amount above the first price may be performed by utilizing the server 145, the database 150, any combination thereof, or any other appropriate device. If the second bid is determined to be at least a predetermined threshold amount above the first price, the method 500 may include, at step 512, granting control of the auction to the second bidder. In one embodiment, the granting of the control of the auction to the second bidder may be performed by utilizing the server 145, the database 150, any combination thereof, or any other appropriate device. If, however, the second bid is determined to be lower than the predetermined threshold amount above the first price, the method 500 may include, at step 514, requesting a response from the first bidder to accept or reject the second bid. In one embodiment, the request for the response from the first bidder may be sent by the server 145 or any other appropriate device to the first bidder device 110. The method 500 may further include receiving the response from the first bidder in response to the request.

At step 516, the method 500 may include granting control of the auction to the second bidder if the response from the first bidder indicates that the first bidder accepted the second bid at the second price. In one embodiment, the granting of the control of the auction to the second bidder may be performed by utilizing the server 145, the database 150, any combination thereof, or any other appropriate device. Finally, at step 518, the method 500 may include providing a reward to the first bidder. In one embodiment, the reward may be a percentage of a difference between the first price and the second price and may be provided once the auction concludes. In one embodiment, the reward may be provided to the first bidder by utilizing the server 145, the database 150, any combination thereof, or any other appropriate device. Notably, the steps of the method 500 may be utilized for any number of additional bidders. Furthermore, the seller and any number of additional bidders may be rewarded for their participation in the auction. In one embodiment, the rewards may be various percentages of increases in the auction price after the initial bid.

In one embodiment, the system 100 and the methods disclosed herein may include creating a currency value for each person involved in an auction. The currency value may be based on any information that may be used to identify an auction participant, how many friends an auction participant/bidder/owner has, how the auction participant has branded themselves online, the buying and selling patterns of the auction participants, what items auction participants view on the web page 200, or any other similar metric. The currency values may be utilized by the system 100 to determine an auction participant's value in motivating people to bid on auctions, ability to recruit people to bid on auctions, or to provide various incentives to those with high currency values. The currency value may also be utilized by the system 100 to single out bidders in an auction that may be of particular interest to the current “virtual owner” so that the “virtual owner” may approve a bidder with a higher currency value so that the auction has a higher chance of being successful. In one embodiment, the system 100 and methods described herein may further include utilizing any of the various components described in the system 100 to perform any of the operative functions disclosed herein.

It is important to note that the methods described above may incorporate any of the functionality, devices, and/or features of the system 100 and subsystems described above, or otherwise, and are not intended to be limited to the description or examples provided herein.

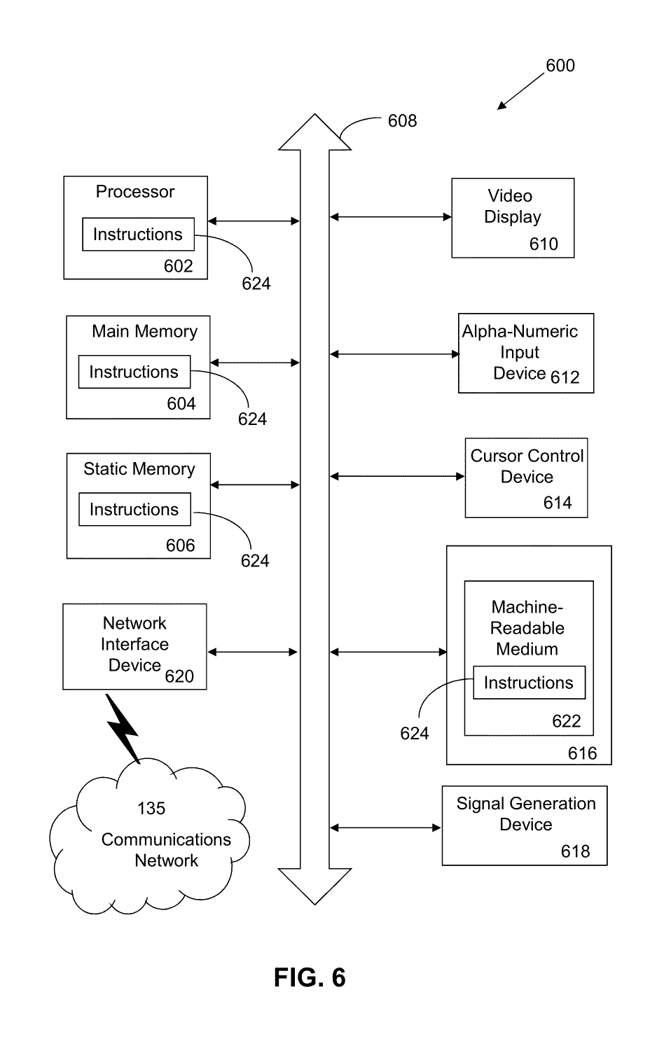

Referring now also to FIG. 6, at least a portion of the methodologies and techniques described with respect to the exemplary embodiments of the system 100 can incorporate a machine, such as, but not limited to, computer system 600, or other computing device within which a set of instructions, when executed, may cause the machine to perform any one or more of the methodologies or functions discussed above. The machine may be configured to facilitate various operations conducted by the system 100. For example, the machine may be configured to, but is not limited to, assist the system 100 by providing processing power to assist with processing loads experienced in the system 100, by providing storage capacity for storing instructions or data traversing the system 100, or by assisting with any other operations conducted by or within the system 100.

In some embodiments, the machine operates as a standalone device. In some embodiments, the machine may be connected (e.g., using a communications network 140) to and assist with operations performed by other machines, such as, but not limited to, the server 145, the database 150, or any combination thereof. The machine may be connected with any component in the system 100. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computer system 600 may include a processor 602 (e.g., a central processing unit (CPU), a graphics processing unit (GPU, or both), a main memory 604 and a static memory 604, which communicate with each other via a bus 608. The computer system 600 may further include a video display unit 610 (e.g., a liquid crystal display (LCD), a flat panel, a solid state display, or a cathode ray tube (CRT)). The computer system 600 may include an input device 612 (e.g., a keyboard), a cursor control device 614 (e.g., a mouse), a disk drive unit 616, a signal generation device 618 (e.g., a speaker or remote control) and a network interface device 620.

The disk drive unit 616 may include a machine-readable medium or device 622 on which is stored one or more sets of instructions 624 (e.g., software) embodying any one or more of the methodologies or functions described herein, including those methods illustrated above. The instructions 624 may also reside, completely or at least partially, within the main memory 604, the static memory 606, or within the processor 602, or a combination thereof, during execution thereof by the computer system 600. The main memory 604 and the processor 602 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium or device 622 containing instructions 624 so that a device connected to the communications network 140 can send or receive voice, video or data, and to communicate over the communications network 140 using the instructions. The instructions 624 may further be transmitted or received over the communications network 140, via the network interface device 620.

While the machine-readable medium or device 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium or device that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

The illustrations of arrangements described herein are intended to provide a general understanding of the structure of various embodiments, and they are not intended to serve as a complete description of all the elements and features of apparatus and systems that might make use of the structures described herein. Many other arrangements will be apparent to those of skill in the art upon reviewing the above description. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure not be limited to the particular arrangement(s) disclosed as the best mode contemplated for carrying out this invention, but that the invention will include all embodiments and arrangements falling within the scope of the appended claims.

The foregoing is provided for purposes of illustrating, explaining, and describing embodiments of this invention. Modifications and adaptations to these embodiments will be apparent to those skilled in the art and may be made without departing from the scope or spirit of this invention. Upon reviewing the aforementioned embodiments, it would be evident to an artisan with ordinary skill in the art that said embodiments can be modified, reduced, or enhanced without departing from the scope and spirit of the claims described below.

We claim:

1. A system for rewarding and motivating non-winning bidders, comprising:
a memory that stores instructions;
a processor that executes the instructions to performing operations, the operations comprising:
listing an item of a seller for an auction for a predetermined amount of time, wherein the item is listed at a first price and the seller has control of the auction;
receiving a first bid for the item from a first bidder at the first price, wherein the first bidder is from a plurality of bidders;
granting control of the auction to the first bidder based on receiving the first bid for the item at the first price;
receiving a second bid for the item from a second bidder at a second price, wherein the second bidder is from the plurality of bidders;
granting control of the auction to the second bidder if the second bid at the second price is at least a predetermined threshold amount above the first price;
requesting a response from the first bidder to accept or reject the second bid at the second price if the second price is lower than the predetermined threshold amount above the first price;
granting control of the auction to the second bidder if the response from the first bidder accepts the second bid at the second price; and
providing a reward to the first bidder, wherein the reward is a first percentage of a difference between the first price and the second price.

2. The system of claim 1, wherein the operations further comprise providing a reward to the seller, wherein the reward to the seller comprises the first price plus a second percentage of the difference between the first price and the second price.

3. The system of claim 1, wherein the operations further comprise transmitting a notification to the second bidder that the second bidder has won the auction if the second bidder is a last bidder when the predetermined amount of time expires.

4. The system of claim 1, wherein the operations further comprise retaining control of the auction with the first bidder if the response from the first bidder rejects the second bid at the second price.

5. The system of claim 1, wherein the operations further comprise listing the auction on a social networking web page of the seller when the item is listed.

6. The system of claim 1, wherein the operations further comprise listing the auction on a social networking web page of the first bidder when the first bidder submits the first bid for the item, wherein the operations further comprise listing the auction on a social networking web page of the second bidder when the second bidder submits the second bid for the item.

7. The system of claim 1, wherein the operations further comprise determining a currency value for the first bidder based at least in part on the first bid, and wherein the operations further comprise determining a currency value for the second bidder based at least in part on the second bid.

8. The system of claim 1, wherein the operations further comprise providing a bonus to a bidder of the plurality of bidders that bids a price that causes a highest price increase for the item during the predetermined amount of time.

9. The system of claim 1, wherein the operations further comprise raising the first price of the item to the second price when the second bidder is granted control of the auction.

10. The system of claim 1, wherein the operations further comprise providing a reward to the seller and each subsequent bidder after the first bidder.

11. The system of claim 1, wherein the control of the auction to the second bidder is removed from the second bidder if a predetermined threshold amount above the second price is met by a subsequent bid by a subsequent bidder of the plurality of bidders.

12. A method for rewarding and motivating non-winning bidders, comprising:
listing an item of a seller for an auction for a predetermined amount of time, wherein the item is listed at a first price;
receiving a first bid for the item from a first bidder at the first price, wherein the first bidder is from a plurality of bidders;
granting, by utilizing instructions from memory and executed by a processor, control of the auction to the first bidder based on receiving the first bid for the item at the first price;
receiving a second bid for the item from a second bidder at a second price, wherein the second bidder is from the plurality of bidders;
granting control of the auction to the second bidder if the second bid at the second price is at least a predetermined threshold amount above the first price;
requesting a response from the first bidder to accept or reject the second bid at the second price if the second price is lower than the predetermined threshold amount above the first price;
granting control of the auction to the second bidder if the response from the first bidder accepts the second bid at the second price; and
providing a reward to the first bidder, wherein the reward is a first percentage of a difference between the first price and the second price.

13. The method of claim 12, further comprising providing a reward to the seller, wherein the reward to the seller comprises the first price plus a second percentage of the difference between the first price and the second price.

14. The method of claim 12, further comprising keeping control of the auction with the first bidder if the response from the first bidder rejects the second bid at the second price.

15. The method of claim 12, further comprising providing a bonus to a bidder of the plurality of bidders that bids a price that causes a highest price increase for the item during the predetermined amount of time.

16. The method of claim 12, further comprising raising the first price of the item to the second price when the second bidder is granted control of the auction.

17. The method of claim 12, further comprising determining a currency value for the first bidder based at least in part on the first bid, and wherein the operations further comprise determining a currency value for the second bidder based at least in part on the second bid.

18. The method of claim 17, further comprising providing a priority to the first bidder over the second bidder if the currency value of the first bidder is higher than the currency value of the second bidder.

19. The method of claim 12, further comprising transmitting a notification to the second bidder that the second bidder has won the auction if the second bidder is a last bidder when the predetermined amount of time expires.

20. A computer-readable device comprising instructions, which when executed by a processor, cause the processor to perform operations comprising:
listing an item of a seller for an auction for a predetermined amount of time, wherein the item is listed at a first price;
receiving a first bid for the item from a first bidder at the first price, wherein the first bidder is from a plurality of bidders;
granting control of the auction to the first bidder based on receiving the first bid for the item at the first price;
receiving a second bid for the item from a second bidder at a second price, wherein the second bidder is from the plurality of bidders;
granting control of the auction to the second bidder if the second bid at the second price is at least a predetermined threshold amount above the first price;
requesting a response from the first bidder to accept or reject the second bid at the second price if the second price is lower than the predetermined threshold amount above the first price;
granting control of the auction to the second bidder if the response from the first bidder accepts the second bid at the second price; and
providing a reward to the first bidder, wherein the reward is a first percentage of a difference between the first price and the second price.
